(19) United States
(12) Patent Application Publication
(10) Pub. No.: US 2007/0119508 A1
(43) Pub. Date: May 31, 2007

(54) Fluid Flow Diversion Valve and Blood Collection System Employing Same

(76) Inventors: Richard L. West, Lake Villa, IL (US); Indrajit T. Patel, Algonquin, IL (US); Lawrence J. Servi JR., Hawthorn Woods, IL (US)

Correspondence Address: BAXTER HEALTHCARE CORPORATION, ONE BAXTER PARKWAY, DF2-2E, DEERFIELD, IL, 60015, US

(21) Appl. No.: 11/564,085

(22) Filed: Nov. 28, 2006

Related U.S. Application Data
(60) Provisional application No. 60/740,312, filed on Nov. 29, 2005.

(51) Int. Cl. F16K 11/085

(52) U.S. Cl. 137/625.47

(57) ABSTRACT

Valves are provided for interconnecting a fluid source to two separate collection zones. The valves include a valve body having an inlet port communicating with the source and two outlet ports, each communicating with one of the collection zones. A valve element received within the valve body selectively establishes fluid communication between the inlet port and an outlet port. In a first position, the inlet port is in fluid communication with one of the outlet ports and the associated collection zone. The valve element is rotated to a second position within the valve body to establish fluid communication between the inlet port and the other outlet port, thereby halting flow through the first outlet port and allowing fluid communication with the other collection zone. A safety feature prevents rotation of the valve element beyond the second position or reverse rotation from the second position to the first position.

### CROSS REFERENCE TO RELATED APPLICATIONS

This application claims priority from and the benefit of provisional patent application Ser. No. 60/740,312, filed Nov. 29, 2005, which is hereby incorporated herein by reference.

### BACKGROUND

1. Field of the Disclosure

The present invention generally relates to flow diversion valves, such as stopcock valves, and more particularly, to flow diversion valves suitable for use in a medical fluid system such as a blood collection system for controlling flow therethrough.

2. Description of Related Art

Systems for collecting blood from healthy donors for later administration to patients have been well known for many years. Such blood collections systems fall into generally two broad categories, manual blood collection systems and automated blood collection systems. Manual blood collection systems are commonly of the type normally seen or used in blood drives, where blood from healthy donors is collected by gravity flow into a blood collection container, which is part of a larger disposable fluid circuit. After collection, the whole blood from the donor is typically centrifugally separated into one or more components, such as red blood cells, plasma and platelets, which are stored in separate containers for later administration to a patient.

Automated systems also commonly use a disposable fluid flow circuit. In automated systems, however, the fluid flow circuit is typically used in combination with a reusable hardware system that aids in separating the blood into one or more component parts as it is collected from the donor. Typical examples of both manual and automated blood collection systems may be found in the products sold by the Transfusion Therapies Division of Baxter Healthcare Corporation of Deerfield, Ill. These may include, for example, manual systems such as Baxter's Single, Double, Triple and Quad Blood-Pack Units and automated systems such as Baxter's Alyx® and Amicus® blood collection systems.

In the collection of blood from a healthy donor, it is well known that it may be desirable to divert the first quantity of blood from the donor into a sample collection container upstream of the remainder of the blood collection or processing system. In addition to collecting a quantity of blood that may be used for testing or other sampling, the diversion of the initial blood flow also serves to divert any initial skin plug that is created by the collection needle when introduced into the arm of a donor. Although, the skin of the donor is commonly swabbed with disinfectant before collection, a donor's skin can still contain bacteria or other microorganisms. Diversion of the initial blood flow into the sample container thus has the added benefit of preventing the initial bacterial burden on the donor's skin from flowing directly into the primary collection container. As a result, blood that is eventually collected from the donor and separated into blood components has a reduced bio-burden, enhancing storage life and safety for the eventual recipient of the blood component in question.

The present invention, is directed, in one aspect, to a flow diversion valve which may be used in blood collection systems, both manual and automated, to direct the initial blood flow from a donor into a sample container and, after a suitable quantity of initial blood flow is collected, to direct the donor blood to the primary collection container or the remainder of the blood collection system. Although the flow diversion valve is described herein in the context of a blood collection system, it may be used elsewhere and is not limited to blood collection systems in particular or to flow control in medical flow systems in general.

### SUMMARY OF THE PRESENT INVENTION

In accordance with the present invention, a flow diversion valve is provided which is particularly well suited for use in blood collection systems for controlling blood flow therethrough. In accordance with one aspect of the present invention, the valve comprises a valve body including an inlet port, a first outlet port and a second outlet port. The valve includes a valve element movable, as by rotation, relative to the valve body between a first (or sampling) position in which the inlet port communicates with the first outlet port and not with the second outlet port, and a second (or collecting) position in which the inlet port communicates with the second outlet port and not the first outlet port. The valve element is preferably pre-positioned in a selected one of the first and second positions. For example, when used in a blood collection system, the valve element is preferably pre-positioned in the sampling position for communication of the donor blood through the outlet port that communicates with a sample container to direct the initial blood flow into the sample container.

In accordance with another aspect of the present invention, interfering surfaces on the valve body and valve element allow movement of the valve element from the selected (e.g., sampling) pre-position to the other of the first and second (e.g., collecting) positions, but prevent movement of valve element beyond a limited range of movement between the first and second positions. Interfering surfaces may also prevent movement of the valve element from the other of the first or second (e.g., collecting) positions. In accordance with these features, in a blood collection system the valve is preferably pre-positioned in the sampling position for flow communication between the valve inlet the outlet port that leads to the sampling container and is movable one time only from that position to a collecting position in which the inlet communicates with the other outlet port that leads to the collection container, at which point the valve element cannot be substantially moved in any direction and is essentially locked in the collecting position.

As described above, the flow diversion valve of the present invention is particularly useful in blood collection systems of the types described above, although its utility is not limited to such systems. One embodiment of the flow diversion valve of the present invention is illustrated in the following drawings, of which;

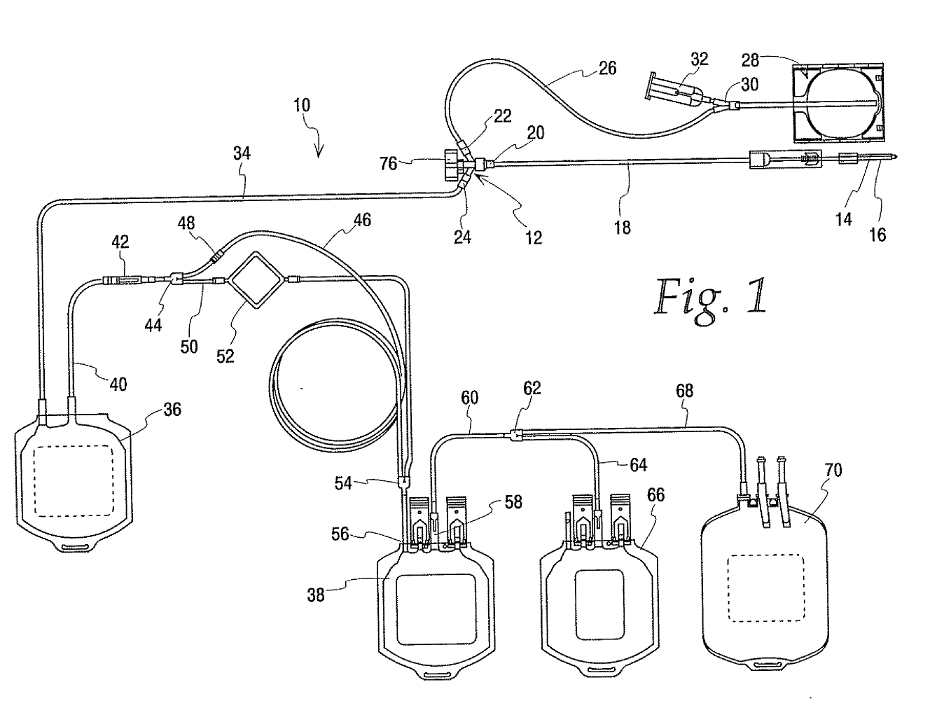

FIG. 1 is a plan view of an exemplary manual blood collection system employing a flow diversion valve of the present invention.

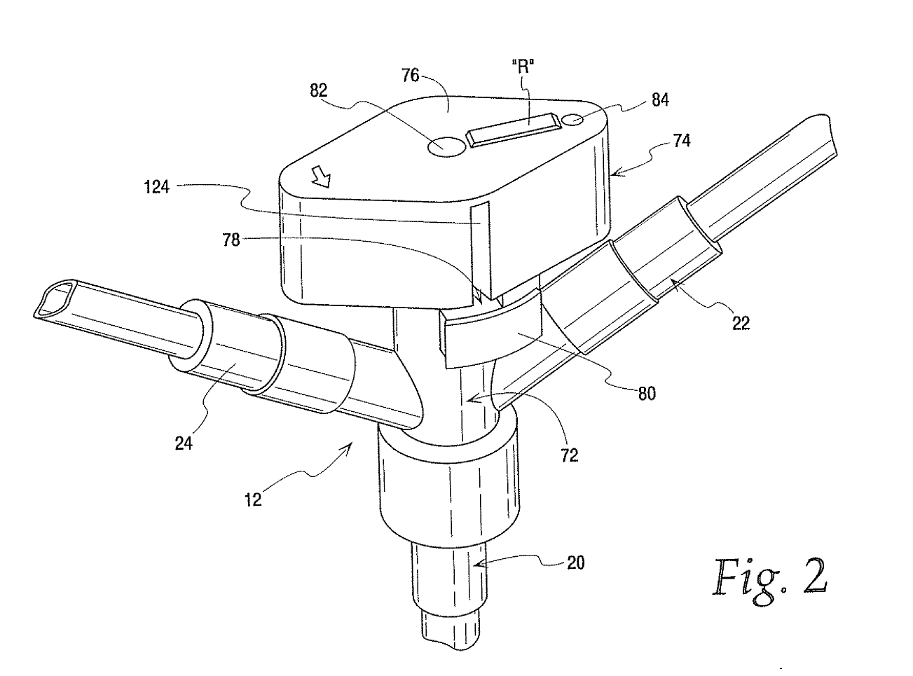

FIG. 2 is a perspective view of the flow diversion valve in FIG. 1 in accordance with the present invention.

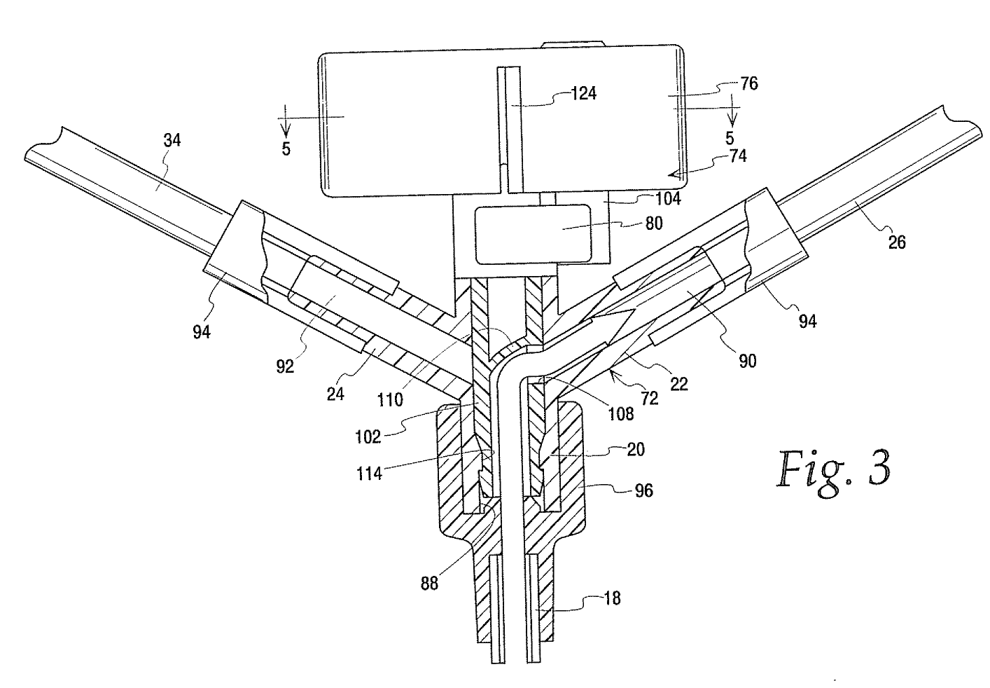

FIG. 3 is a partial cross-sectional view of the flow diversion valve of FIG. 2, illustrating the valve element in a selected pre-position, e.g., a sampling position.

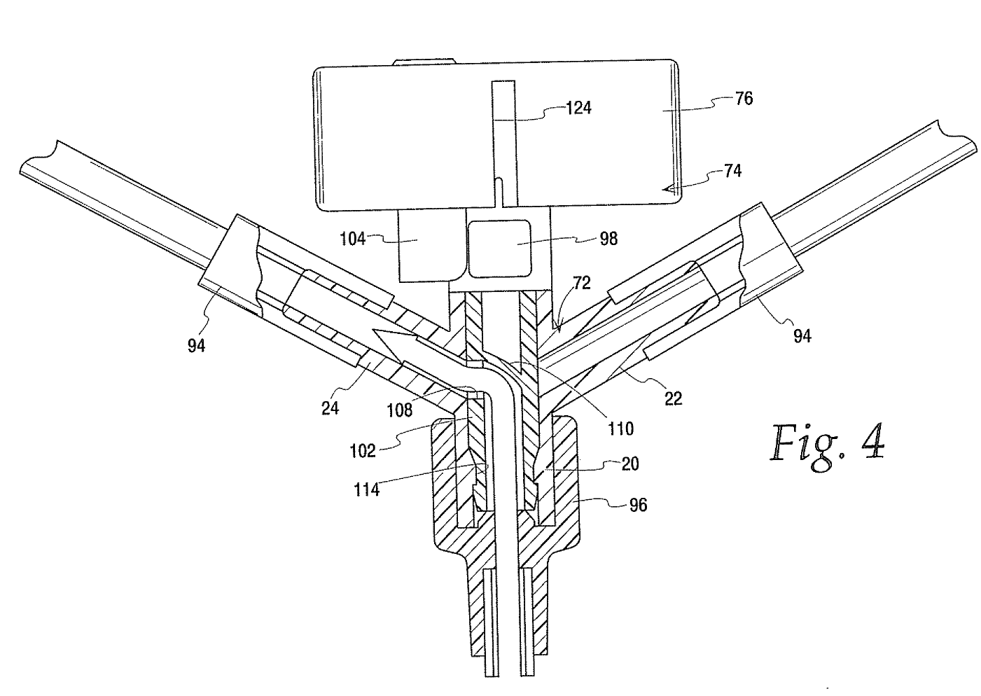

FIG. 4 is a partial cross-sectional view, illustrating the valve in the other position, e.g., a collecting position.

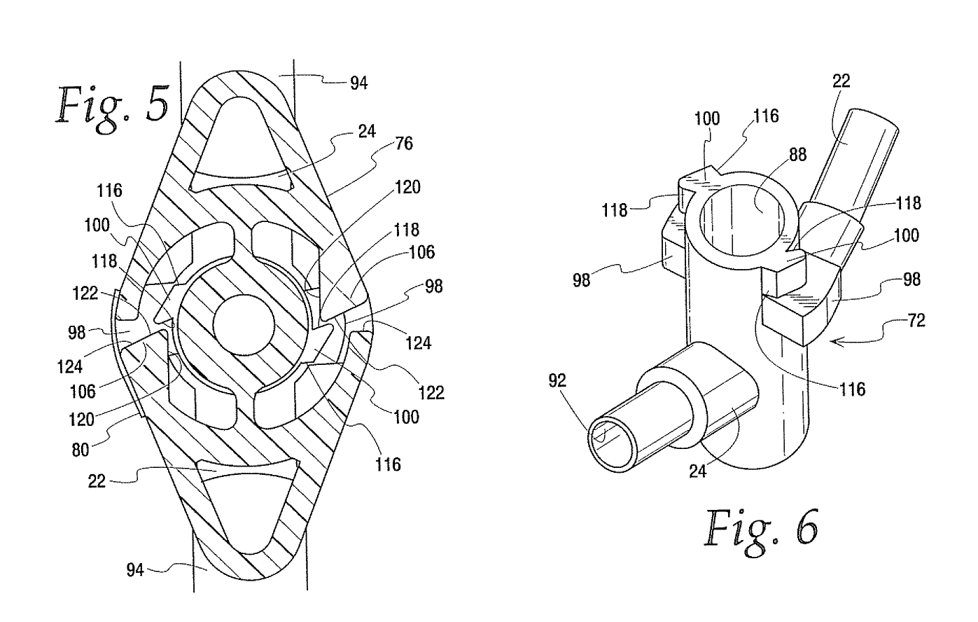

FIG. 5 is a sectional view taken along lines 5-5 in FIG. 3.

FIG. 6 is a perspective view of the valve body employed in the valve of FIG. 2.

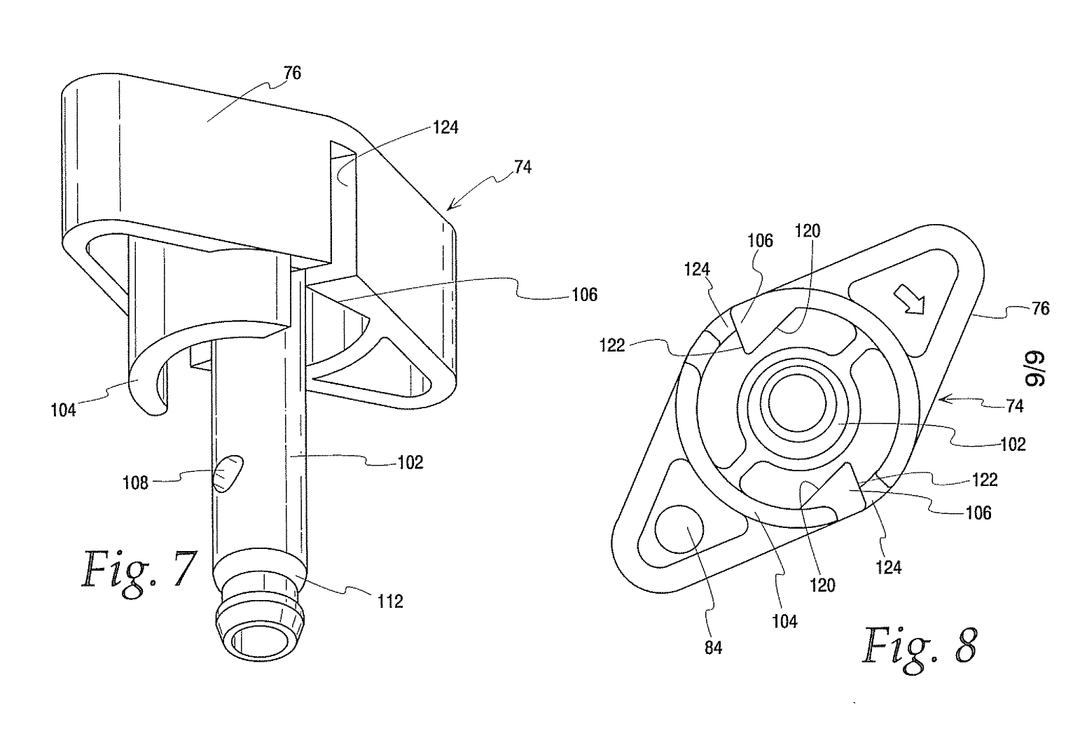

FIG. 7 is a perspective view of the valve element employed in combination with the valve body of FIG. 6.

FIG. 8 is a bottom view of the valve element of FIG. 7.

### BLOOD COLLECTION SYSTEM

Turning now to a more detailed description of the attached drawings, FIG. 1 is a plan view of a manual blood collection system 10 employing a flow control or diversion valve 12 of the present invention. As noted earlier, the flow diversion valve 12 is shown in this embodiment for purposes of illustration only, and is not limited to use in blood collection systems, either manual or automated. Notwithstanding the above, the flow diversion valve 12 affords significant benefits when used in combination with blood collection systems such as that illustrated in FIG. 1.

For removing blood from a donor, the blood collection system includes a needle 14, which is temporarily enclosed in a protective over-sheath 16 until the system is used, at which time the over-sheath is removed, exposing the needle for accessing a donor vein. The needle 14 is connected, via tubing 18, to the flow diversion valve 12 embodying the present invention.

As may be seen in FIG. 1, the flow diversion valve 12 includes an inlet port 20 which is connected to the donor tubing 18, a first outlet port 22 and a second outlet port 24. The first outlet port is connected via tubing 26 to a flexible sample container or pouch 28. A sample withdrawal port 30 in tubing 26 is attached to a vacuum sample tube holder 32, allowing removal of blood samples from the sample collection container 28. More details regarding the sample container and sample tube holder are set forth in U.S. patent applications Ser. Nos. 11/250,717, filed Oct. 13, 2005, and 10/295,151, filed Nov. 15, 2002 (publication no. 2003/0176813), which are hereby incorporated by reference. Preferably, the sample collection container 28 has a volume of about 50 ml for collecting sufficient blood for testing or analysis.

The second outlet port 24 of the flow diversion valve 18 is attached to tubing 34 which extends to a primary collection bag or flexible container 36. The primary collection container 36 is the initial container into which whole blood is collected from the donor (after the sample is collected in the sample container), and may include a quantity of anti-coagulant, such as CPD or ACD to prevent clotting of blood collected in the primary collection container. The volume of the primary collection is typically about 450-500 ml.

The primary collection container 36 is connected to one or more satellite containers. As may be seen in FIG. 1, the primary collection container 36 is connected to a second container 38 by way of a first tubing segment 40 that includes a frangible flow control valve 42 of the type commonly found in medical fluid flow systems and blood collection sets. Such a valve is normally closed and may be opened by manually flexing the tubing, causing the frangible member within the tubing to break and open to allow flow through the tubing.

Downstream of the frangible connector, the fluid flow path includes a Y-connector 44. One branch of the Y-connector 44 communicates with a vent tube 46 through a one way flow valve 48 that normally prevents blood from flowing through tubing 46 from the primary collection container 36 to the second collection container 38.

The other branch of the Y-connector 44 is connected to a tubing segment 50 that includes a leukocyte depletion filter 52. As described in more detail, the leukocyte depletion filter, which may be of well known construction, removes white cells from the collected whole blood when the whole blood is transferred to the second collection container. Removal of white cells may reduce possible adverse reaction by patients who receive components of the collected whole blood. Tubing 46 and 50 rejoin at Y connector 54 upstream of inlet 56 to the second collection container.

The second container 38 is a flexible plastic bag or pouch of essentially standard construction and materials of a type that is well known in blood collection systems and is described in connection with blood collection systems in numerous patents and prior art documents. These features do not form a part in the present invention except to the extent provided as part of the system shown in FIG. 1, in which the flow diversion valve 12 is employed. Accordingly, the detailed description of the second (and other) collection containers will not be provided.

The second collection container has an outlet 58 that communicates, via tubing 60, with Y-connector 62. One branch of the Y-connecter 62 communicates via tubing 64 with a third collection or satellite container 66 and the other branch of the Y-connector 62 communicates, via tubing 68, with a fourth collection container 70.

### Flow Diversion Valve

The flow diversion valve of the present invention is illustrated, in perspective view, in FIG. 2. As shown there, the flow diversion valve 12 includes a valve body 72 and a valve element 74 that is rotatably movable relative to the valve body to control the direction of flow through the valve. The valve element has an exposed handle 76, which may be manipulated by a user to change the direction of flow through the valve.

In accordance with a preferred aspect of the flow diversion valve, the valve is pre-positioned before shipment to the customer or end-user so that blood first flowing into the inlet port 20 of the valve is directed through the first or sampling outlet port 22 and into the sample container 28. This is to assure that the first quantity of blood from the donor, which may include the skin plug and any bacteria or micro-organisms resident on the donor's skin, flows into the sample container.

In that regard, the valve preferably includes a visual and/or tactile indicator that informs the user that the valve is in the proper position for collection of the initial blood flow into the sample container and indicates to the user if the valve has been moved from that position. In the illustrated and preferred embodiment, the indicator 78 is in the form of tamper proof tape 80 that is in contact with the valve body and the movable valve element. Removal of the tape or damage/deformation to the tape would indicate to the user that the valve has been moved or that someone has attempted to turn the valve element or has otherwise improperly tampered with the system. Accordingly, if the user observes that the tamper proof tape has been removed or is damaged or deformed, the user will be alerted to the potential misuse of that particular product and can discard it for another product to be used with the donor. The tamper proof tape may take various forms and be used in different ways. For example, the tamper proof tape may be removable by the user so that when the user needs to change the direction of flow, the tape is removed to allow turning of the valve element. If the tape is removable, then it may be preferred that it cannot be effectively reapplied after it is initially removed, otherwise the tamper proof function may be circumvented. Alternatively, the tamper proof indicator (tape or otherwise) may include a weakened section, such as by serration or a thinned area, which breaks when the valve element is turned. In either situation, the user is informed as to whether the valve is in the proper initial position and whether the valve has been moved.

Although illustrated in the form of tape, the tamper indicator may also have other forms without departing from the present invention. For example, the tamper indicator may be any material of sufficiently low strength (e.g., paper) that can be removed, damaged, or deformed to evidence tampering as described above. Alternatively, a shrink wrap band, frangible collar or other device or arrangement could also be used to inform the user when the valve has been moved or otherwise improperly handled.

As also shown in FIG. 2, for the benefit of the user, the valve element handle 76 includes visual and tactile indicators showing the direction of flow through the valve and depicting the only direction in which the valve element may be turned. More specifically, the flow direction is evidence by a center opening or recess 82 in the valve handle and a displaced opening or recess 84 in the valve handle with a raised rib (“R”) extending between them so as to visually and tactilely indicate that the flow is in the direction from the inlet to the port which is aligned with the displaced recess or opening. For example, as seen in FIG. 2, the valve element is in the pre-selected position in which the center inlet port 20 is in flow communication with the first outlet port 22 and to the sample container 28. A large arrow molded into the valve element handle 76 indicates the only turn direction in which the valve element may be turned.

FIG. 3 is a partial cross-sectional view of the flow diversion valve 12, illustrating the direction of blood flow when the valve is in the initial pre-selected position and showing in more detail the various components of the flow diversion valve. As may be seen in FIG. 3, the valve body 72 has a generally elongated cylindrical center bore 88 and side bores 90 and 92 that communicate with the center bore and extend through angled branch or side arms forming the inlet and outlet ports 20 and 22. The valve body is preferably formed of rigid plastic material, and may be made of any material suitable for contact with blood, such as a polycarbonate material. Also, the valve material and construction is preferably suitable for different types of sterilization, such as autoclave, radiation and/or ethylene oxide.

A bushing arrangement is employed to connect the plastic fluid flow tubing to the valve body. The fluid flow tubing connected to the valve may be made of other suitable plastic materials, such as polyvinylchloride. In the illustrated embodiment, the tubing is attached to the valve body in a manner to reduce voids or dead spaces that may tend to accumulate blood or promote blood clotting. For example, the tubing is preferably in face to face, abutting contact with the end of the particular branch or arm forming the inlet or outlet port to which the tubing is connected. Also, the inside diameter of the tubing is generally the same as the inside of the diameter of the bore or passageway 90 or 92 through the side arm of the inlet or outlet port so that blood flow is relative smooth and uninterrupted and turbulence minimized.

The tubing is affixed to the respective side arm by a bushing 94. The bushing 94 may be made of PVC material and is preferably solvent bonded to the tubing prior to attachment to the valve body. The bushing is sized for tight friction fit over the arm of the valve body to hold the tubing in tight, abutting engagement with the end of the respective side arm of the valve body. During heat sterilization, the bushing forms a tight and reliable bond with the side arm of the valve body. Similarly, the inlet tubing 18 is attached to the center inlet port 20 of the valve body by bushing 96.

According to a preferred method of assembling a fluid processing set 10, the flow diversion valve 12 is assembled and sterilized by radiation (e.g., electron beam or gamma). As per the foregoing description, the bushings are press-fit over the inlet and outlet ports of the valve body, so the surface of the ports must be sterilized prior to fixation of the tubing. When the valve 12 has been so sterilized, it is connected to the remainder of the fluid processing set 10 by the bushings and tubing, and the set 10 is subjected to steam treatment. The steam treatment simultaneously sterilizes the set 10 and bonds the bushings to the inlet and outlet ports. By this two-step sterilization process, a sterile barrier is maintained at all points of the system, most notably at the handle-center bore interface and the port-bushing interfaces.

To limit the movement of the valve element, as most clearly seen in FIG. 6, the valve body includes a pair of opposed stops or stop members 98 and a pair of opposed latches 100. As will be described in more detail later, the stops 98 limit the range of rotation of the valve element so that it is aligned, at one end of the range, with the sampling port, and at the other end of the range, with the collecting port. The latches serve to lock the valve element in place when it is rotated to the collecting position and prevent return to the initial sampling position.

The valve element 74 is best seen in FIGS. 5-7. The valve element is also preferably made of molded rigid plastic material, such as a polycarbonate material. The valve element has an elongated generally cylindrical hollow center extension member 102, which extends from the handle 76, for insertion into center bore 88 of the valve body. A stop engagement member 104 depends from the handle, for engagement with stop members 98 on the valve body. The handle also includes pawls 106 positioned on opposite sides of the handle for engagement with latches 100 on the valve body to lock the valve element in the collecting position, as will be more fully described below.

As best seen in FIGS. 3 and 7, the hollow center extension or member 102 of the valve element has a side port 108 for communication between the internal bore of the center extension 102 and the inlet or outlet ports of the valve body. To prevent blood from collecting within the bore of the center extension above the side port, a barrier 110 is located within the bore of the center member to direct blood flow through the side port. Preferably, the barrier is inclined to deflect blood directly into the side port and reduce dead spaces that might create a potential for clotting.

The valve element and valve body are assembled by inserting the center extension or member 102 of the valve element into the center bore 88 of the valve body, with the upper end of the valve body extending into the underside of handle 76 so that the latches 100 on the valve body are positioned to cooperate with pawls 106 on the handle. The stop engagement member 104 of the valve element handle is located between the stops 98 of the valve body, which serve to limit the range of rotation of the valve element.

The center extension 102 of the valve element and the center bore 88 of the valve body are sized for tight close-fitting relationship to allow rotation while substantially preventing fluid leakage between them. To hold the valve element 74 securely within the valve body 72, the center extension 102 of the valve element has an annular groove 112 that receives a raised annular rib 114 located on the inside of center bore 88. A leading surface of the raised rib is tapered to ease insertion of the valve element past the raised member. Engagement between opposing shoulders of the annular groove 112 and raised rib 114 retain the valve element within the valve body and provide additional sealing against fluid leakage between the valve element and valve body. The valve element center extension 102 also preferably extends to a position closely adjacent to the bushing 96 so that incoming blood flows directly from the inlet tubing 18, through the bushing 96 and into the bore of the valve element extension 102, with limited dead spaces or voids in the valve for potential blood clotting.

FIG. 4 is similar to FIG. 3 except that it shows the valve element 74 rotated so that flow from the inlet port 20 communicates with the second or collecting port 24. Because there is only a single side port 108 in the valve element 74, flow from the inlet port 20 can only communicate with one or the other of the outlet ports 22 and 24 and cannot communicate with both simultaneously. In other words, the valve element can be positioned to direct flow between the inlet port and the first or sampling port, in which position it cannot communicate with the second port, or when the valve element can be positioned to direct flow between the inlet port and the second port, it does not communicate with the first port, so that blood from the inlet port can pass through only one outlet port.

In accordance with one aspect of the present invention, the valve element 74 can only be fully rotated one time, in one direction and to a limited extent. More specifically, as noted early, the flow diversion valve 12 is preferably pre-positioned, so that the initial blood flow from the donor is directed through the first or sampling outlet port 22 and into the sample container 28. The tamper proof indicator informs the user that the valve is in the proper pre-position and has not been moved or otherwise tampered with after it has left the factory.

After the desired quantity of blood is collected from the initial flow into the sample container 28, the valve element 74 is then rotated by the user to divert the incoming blood to the primary collection container 36. Preferably, the valve element 74 and valve body 72 are adapted to allow rotation without damaging the cells flowing through the valve 12. In accordance with an aspect of present invention, the valve 12 allows the user to rotate fully in one direction only. In addition, the valve limits the arc of rotation, so that rotation is stopped when the valve is properly aligned with that the inlet port 20 communicating with the second (collecting) outlet port 24. In addition, the valve element locks in the second (collecting) position to prevent the user from rotating it back to the first (sampling) position. Accordingly, the valve can only be rotated to align the inlet port with the second or collecting port one time, and thereafter no further rotation of the valve element is practically possible.

This feature of the valve is provided by interfering surfaces between the valve element 74 and valve body 72. First, as may be seen in FIGS. 3-7, the valve body includes the pair of opposed raised stops or stop members 98 that limit the range of rotational movement of the valve so that it is aligned, at the ends of its rotation, with either the first outlet port (also referred to as the first or sampling position) 22 or the second outlet port 24 (also referred to as the second or collecting position). The cooperating stop engagement member 104 depending from the handle 76 engages one of the stops 98 when the valve is in communication with either the first outlet port 22 or the second outlet port 24. In other words, the stop engagement member 104 of the valve element can move only between the stop members 98 on the valve body, and the stop members prevent any further rotation of the valve element beyond the stop member. Accordingly, when the valve is pre-positioned during manufacture so that the inlet port 20 of the valve communicates with the first outlet port 22, the stop engagement member 104 of the valve element 74 is in contact with one of the stop members 98 located on the valve body and can turn no further in a clockwise direction (as seen in FIG. 5). When the user rotates the valve element to divert the incoming blood to the primary collection container 36, the valve element may be rotated in only one direction (counterclockwise in FIG. 5), and may be rotated in that direction only until the valve element stop engagement member 104 contacts the opposed stop member 94 on the valve body, at which point the inlet port will be in communication with the second outlet port 24.

In accordance with another aspect of the present invention, once the valve is in the second (or collecting position) the valve prevents the user from rotating the valve element 24 away from that position, effectively locking the valve into that position. As those terms are used in this description, “locking” the valve in that position or “preventing rotation” away from that position is intended to refer to normal usage of the valve with reasonable amounts of force and the features of the present invention may not prevent movement of the valve if the user applies such overriding force that amounts to an abuse of the valve or causes destruction or breakage of the valve.

The locking feature of the illustrated flow diversion valve 12 is provided by interfering surfaces in the form of the latches and pawls that are mounted on the valve body and the valve element. As best seen in FIGS. 5 and 6, the pair of opposed latches 100 are located on the upper end of the valve body and extend outwardly from the valve body 72. Each latch includes an inclined or tapered lead surface 116 and an undercut or hook surface 118 opposite the lead surface. The handle 76 of the valve element 74, as best seen in FIGS. 5 and 8, includes the pair of cooperating pawls 106. As seen in FIG. 5, each pawl 106 of the valve element 74 has a tapered lead surface 120 and an undercut surface 122.

The cooperation between the latches 100 and pawls 106 may be better understood with reference to rotation of the valve element 74 relative to the valve body 72. In the first or sampling position, the valve inlet port 20 is in communication with the first sampling outlet port 22 (also referred to as the pre-position) to divert from the initial blood flow to the sample container 28. In that position, stop member 98 of the valve body abuts stop engagement member 104 of the valve element. When the user wishes to divert the blood flow to the primary collection container 36, the tamper proof tape is removed or broken, and the valve element 76 is rotated counterclockwise, as illustrated in FIG. 5. As the valve element is rotated, the inclined lead surface 120 of pawl 106 engages the inclined lead surface 116 of latch 100 so that the pawl rides up and over the latch, due to the resiliency of the plastic material of the valve element.

To reduce the force required to rotate the valve element and allow temporary expansion of the pawls and enlargement of the handle, expansion slots 124 are provided in the handle side wall to accommodate the movement of the pawls over the latches. After the pawls rotate past the latches, the inherent resiliency of the plastic material of the valve element returns or snaps the pawls back into the usual or radially inward position, so that the undercut surfaces of the pawls and latches are in a facing relationship. Engagement between the facing undercut surfaces of the latches and pawls prevents the valve element 74 from being rotated clockwise (as in FIG. 5) toward the first sampling position. Thus, in the second or collecting position, the valve element 74 is essentially locked in place—interference between the stop engagement member 104 of the valve element and one of the stop members 98 of the valve body prevents the valve element from being rotated further in a counterclockwise direction, as seen in FIG. 5, and engagement between the undercut surfaces of the pawls and latches prevent the valve element from being rotated significantly in a clockwise direction as shown in FIG. 5. Thus the valve element is fixed in the collecting position in which the inlet port 20 is in communication with the second outlet port 24 for diversion of the blood flow to the primary collection container 36.

Turning now to the operation of the overall system, as noted earlier, the manual blood collection system 10 as shown in FIG. 1 is merely one example of the type of system in which the valve of the present invention may be used. Referring to that system for purposes of illustration, when the system is provided to the user, the flow diversion valve 12 is in the selected pre-position (or first or sampling position) in which the initial blood flow from the donor is diverted into the sample container 28. The proper position of the valve is indicated by the tamper indicator, such as tamper proof tape 80.

After determining that the flow diversion valve has not been tampered with, the phlebotomist inserts the needle 14 into the donor's vein. The initial blood flow from the donor enters the inlet 20 of the valve and exits through the first outlet port 22 to the sample container 28 until sufficient initial quantity of blood is collected for sampling and testing purposes. After the initial blood flow is collected in the sample container, the attendant removes or breaks the tamper proof tape or addresses such other tamper-evident structure as may be used on the valve, and rotates the valve to the second or collecting position, in which the inlet port is in communication with the second outlet port (and not the first outlet port) so that incoming blood flow is diverted to the primary collection container 36. At that point, the attendant is effectively prevented from rotating the valve any further in either a clockwise or counterclockwise direction due to the interfering surfaces discussed above.

While the donor blood is being collected in the primary collection container, the attendant may take such samples as are desired for testing. This may be carried out using standard vacuum vials, which access the sample container using the sample port and sample tube holder 30 and 32. Also, the tubing 26 may be sealed and separated from the remainder of the collection system at that time or later, as desired.

After the desired quantity of blood is collected into the primary collection container, the tubing 34 may be sealed and severed. The frangible flow control member 42 is then opened, and the whole blood is drained from the primary collection container 36 through the leukocyte reduction filter 52 and into the second container 38. The one way valve 48 in tubing 46 prevents blood from the primary collection container from by-passing the leukocyte reduction filter. As a result of filtration through the leukocyte reduction filter, the blood collected in the second container is substantially free of leukocytes.

The second collection container and the remainder of the system, while remaining assembled, may be centrifuged to separate the more dense red cells from the plasma and platelets of the whole blood collected from the donor. After centrifugation, the plasma and whole blood may be expressed from the second collection container through the tubing 60 to one of the other collection containers, such as the fourth collection container. The third collection container may include a quantity of red cell preservative solution, such as Adsol® Solution supplied by Baxter Healthcare Corporation. After the plasma and platelets are expressed to the fourth container, the Adsol® solution may be expressed from the third container to the red cells that still reside in the second collection container. The fourth container may be further centrifuged to separate platelets from the remaining plasma, with the platelet concentrate residing at the bottom of the bag. The platelet-reduced plasma then may be expressed from the fourth collection container to the third collection container (which has been emptied of red cell solution) and the individual containers may be sealed and severed from the remainder of the system. As a result of this blood collection procedure, the user has obtained leukocyte-reduced red cells in one container, leukocyte-reduced and platelet-reduced plasma in another container and leukocyte-reduced platelet concentrate in a third container. Before the containers are sealed and severed, excess air in the container(s) may be vented by squeezing the container(s) and venting the air through the respective communicating tubing, through the tubing 46 and through the one way valve element 48 to the original primary collection container. This may be done sequentially starting with the fourth container and sealing it after the air is expressed and then proceeding to the next container until all the air is expressed to the primary container and the other containers are sealed and severed.

From time to time, the terms “inlet” and “outlet” were used herein to refer to components of valves according to the present invention. These terms refer to the orientation of the components in applications involving a single fluid being delivered to two separate locations, such as blood from a donor being delivered to a sample pouch and a primary collection container. However, valves according to the present invention may be used in applications where fluid passes into the valve through one of the “outlet” ports and leaves the valve through the “inlet” port. For example, a first fluid may flow through the first outlet port 22 and out the inlet port 20, and then the valve element 74 may be moved to the second position to allow a second fluid to flow through the second outlet port 24 and out the inlet port 20. The reconstitution or sequential mixing of certain fluid medicaments are exemplary of applications requiring such flow. Hence, the terms “inlet” and “outlet” are not to be understood as limiting the described valves to particular applications or as limiting the scope of the claims.

The present invention is shown in the enclosed drawings for the purpose of illustration and not limitation, and it is intended that the scope of this invention be in accordance with the claims now and hereafter filed with respect to the subject matter described herein and not limited to the embodiment described unless expressly required by the claims.

1. A flow diversion valve comprising:
a valve body having an inlet port, a first outlet port, and a second outlet port;
a valve element at least partially received within the valve body, defining an internal bore and a single side port communicating with the internal bore, and rotatable relative to the valve body between a first position in which the inlet port communicates through the internal bore and the side port with the first outlet port and not with the second outlet port and a second position in which the inlet port communicates through the internal bore and the side port with the second outlet port and not with the first inlet port, the valve element being pre-positioned in the first position;
first interfering surfaces on said valve element and said valve body allowing rotation of the valve element from the first position to the second position and preventing reverse rotation of the valve element from the second position to the first position; and
second interfering surfaces on said valve element and said valve body preventing rotation of the valve element beyond the second position.

2. The flow diversion valve of claim 1, wherein said first and second interfering surfaces cooperate to lock the valve element in the second position.

3. The flow diversion valve of claim 1, wherein said first interfering surfaces comprise a first pawl and a first latch, said first pawl and said first latch each including an inclined lead surface and an undercut surface, the lead surfaces adapted to allow rotation of the first pawl beyond the first latch to move the undercut surfaces into facing relationship with each other.

4. The flow diversion valve of claim 3, wherein rotation of the first pawl beyond the first latch places the valve element in the second position and the facing undercut surfaces prevent reverse rotation of the valve element from the second position to the first position.

5. The flow diversion valve of claim 3, further comprising a second pawl generally diametrically spaced from the first pawl and a second latch generally diametrically spaced from the first latch, wherein said second pawl and latch are adapted to operate substantially simultaneously with the first pawl and latch.

6. The flow diversion valve of claim 3, further comprising an expansion slot associated with one of the valve element and the valve body to allow deformation of at least a portion of the valve element or the valve body when the lead surface of the first pawl is rotated against the lead surface of the first latch.

7. The flow diversion valve of claim 6, further comprising a handle portion of the valve element, wherein the expansion slot is associated with said handle portion to allow deformation of the handle portion when the lead surface of the first pawl is rotated against the lead surface of the first latch.

8. The flow diversion valve of claim 7, wherein said handle portion is comprised of a resiliently deformable material and adapted to automatically return to a non-deformed condition when the first pawl is rotated beyond the first latch.

9. The flow diversion valve of claim 1, further comprising a visual and/or tactile indicator to show the direction of fluid flow through the valve.

10. A valve for use in a medical fluid processing system comprising:
a valve body including an inlet port, a first outlet port and a second outlet port;
a valve element at least partially received within the valve body to control flow therethrough and rotatable relative to the valve body between a first position in which the inlet port communicates with the first outlet port and not with the second outlet port and a second position in which the inlet port communicates with the second outlet port and not with the first outlet port; and
a tamper evident member cooperative with the valve element and the valve body to indicate movement of the valve element from a selected pre-position.

11. The valve of claim 10, wherein said tamper evident member indicates movement of the valve element from the first position.

12. The valve of claim 10, wherein at least a portion of said tamper evident member is adapted to break when the valve element is moved from the pre-position.

13. The valve of claim 10, wherein said tamper evident member must be removed to allow movement of the valve element from the pre-position.

14. The valve of claim 13, wherein said tamper evident member comprises tamper proof tape.

15. A fluid processing set comprising:
a first collection container;
a second collection container; and
a valve comprising
a valve body having an inlet port, a first outlet port communicating with the first collection container, and a second outlet port communicating with the second collection container,
a valve element at least partially received within the valve body, defining an internal bore and a single side port communicating with the internal bore, and rotatable relative to the valve body between a first position in which the inlet port communicates through the internal bore and the side port with the first outlet port and not with the second outlet port and a second position in which the inlet port communicates through the internal bore and the side port with the second outlet port and not with the first inlet port, the valve element being pre-positioned in the first position,
first interfering surfaces on said valve element and said valve body allowing rotation of the valve element from the first position to the second position and preventing reverse rotation of the valve element from the second position to the first position, and
second interfering surfaces on said valve element and said valve body preventing rotation of the valve element beyond the second position.

16. The fluid processing set of claim 15, wherein said first collection container comprises a blood sample pouch and said second collection container comprises a main collection container.

17. The fluid processing set of claim 15, further comprising a tamper evident member cooperative with the valve element and the valve body to indicate movement of the valve element from the first position.

18. The fluid processing set of claim 17, wherein at least a portion of said tamper evident member is adapted to break when the valve element is moved from the first position.

19. The valve of claim 17, wherein said tamper evident member must be removed to allow movement of the valve element from the first position.

20. The valve of claim 19, wherein said tamper evident member comprises tamper proof tape.
